(19) United States
(12) Patent Application Publication
(10) Pub. No.: US 2008/0089679 A1
(43) Pub. Date: Apr. 17, 2008

(54) Iris for photographing apparatus

(75) Inventors: Sung Bong Kim, Pyeongtak-si (KR); Woo Seong Tak, Osan-si (KR); Se Woong Park, Osan-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/797,729

(22) Filed: May 7, 2007

(30) Foreign Application Priority Data
Oct. 11, 2006 (KR) 10-2006-0098817
Oct. 11, 2006 (KR) 10-2006-0098899

(51) Int. Cl. G03B 9/02

(52) U.S. Cl. 396/507; 396/510

(57) ABSTRACT

Provided is an iris for a photographing apparatus. The iris includes a plate, a plurality of iris wings, a motor, and a filter unit. The plate includes a transmission hole therein. The plurality of iris wings are movably provided on one side of the plate. The motor provides power used to move the iris wings. The filter unit is provided inside the iris wings to control an amount of transmitted light that passes through the transmission hole, and the filter unit is at least portions of the iris wings.

### BACKGROUND

1. Field

The present invention relates to an iris for a photographing apparatus.

2. Description of the Related Art

Generally, a photographing apparatus is an apparatus for recording image signals generated by shooting an object on a recording medium through a predetermined image process. Shooting of an object is performed by an image sensor provided to a photographing apparatus. Examples of the photographing apparatus include cameras and closed circuit televisions (CCTVs).

For the photographing apparatus to more clearly shoot an object, an appropriate amount of light incident onto an image sensor should be maintained. For this purpose, the photographing apparatus includes an iris for controlling an amount of light incident onto the image sensor.

That is, the photographing apparatus provides a function of optimizing an amount of light incident onto the image sensor by automatically controlling an amount of openness of the iris. The photographing apparatus opens the iris to increase an amount of light incident onto the image sensor when an object is dark, and closes the iris to reduce an amount of light incident onto the image sensor when an object is bright.

FIG. 1 is a view illustrating a related art iris for a photographing apparatus, and FIG. 2 is a view illustrating an iris wing of the related art iris.

Referring to FIGS. 1 and 2, the related art iris of the photographing apparatus includes a plate 1, a first iris wing 2 and a second iris wing 3 formed of opaque material that does not transmit light and coupled to the plate to be movable in right and left directions, neutral density (ND) filters 5 and 6 coupled and fixed in the first and second iris wings 2 and 3, respectively.

Also, as illustrated in FIG. 2, a hole 4 allowing light to pass therethrough is formed in the center of the first iris wing 2. The second iris wing 3 also includes a hole formed in its center to allow light to pass through the hole. Here, the hole 4 is a region through which light passes by 100%. Also, a transmission hole of a predetermined size is formed in the inner side of the plate 1 to allow light to be incident onto the image sensor.

Therefore, as the first and second iris wings 2 and 3 move horizontally, a size of the hole through which light can pass changes. The iris can control an amount of light incident onto a predetermined image sensor (not shown) using such an operation.

Here, the ND filters 5 and 6 are formed of a semi-transparent material to transmit half or one fourth of light, and is designed for extending a range in which the iris can control an amount of light incident onto the image sensor.

In other words, in the case where the iris controls an amount of light incident onto the image sensor solely by the hole whose size is controlled by horizontal movements of the first and second iris wings 2 and 3, a control range of an amount of light that passes through the hole gets rough. However, in the case where the ND filters 5 and 6 are provided to the first and second iris wings 2 and 3 and installed to screen a transmission hole formed in the plate 1, an amount of transmitted light can be controlled in various ratios such as 50% and 25% in the regions of the ND filters 5 and 6. Therefore, a range where an amount of light incident onto the image sensor can be controlled can extend.

However, the related art iris for the photographing apparatus is coupled such that the ND filters 5 and 6 overlap the first and second iris wings 2 and 3. Therefore, the thickness of the iris increases due to a four-folded iris structure. Generally, since a portion of the photographing apparatus in which the iris is installed should be formed very thin, the thickness of the iris needs to be thin.

Also, a related art iris for a photographing apparatus is configured such that the first and second iris wings 2 and 3 and the ND filters 5 and 6 move horizontally. Therefore, the first and second iris wings 2 and 3 and the ND filters 5 and 6 interfere with each other, the ND filters 5 and 6 are separated from the iris wings 2 and 3.

Also, since the exposure surface of the ND filters 5 and 6 in a related art iris for a photographing apparatus is large, light reflection is seriously generated. Such reflection generates a ghost to an image obtained by a photographing apparatus.

Also, to improve image quality and reliability of auto focus performance of a lens, the ND filters 2 and 3 of a related art iris for a photographing apparatus are processed in various shapes such as a line shape, circular shape, and V-shape, and attached onto the first and second iris wings 2 and 3.

However, it is difficult to separately process the ND filters 2 and 3 in various shapes such as a line shape, circular shape, and V-shape, and attach the processed ND filters 2 and 3 onto the iris wings.

### SUMMARY

Accordingly, the present invention is directed to an iris for a photographing apparatus that substantially obviates one or more problems due to limitations and disadvantages of the related art.

An object of the present invention is to provide an iris for a photographing apparatus having a thin thickness and simple structure by integrally forming an iris wing and an ND filter.

Another object of the present invention is to provide an iris for a photographing apparatus that can minimize mutual hooking between an iris wing and an ND filter while the iris wing moves horizontally by integrally forming an iris wing and an ND filter.

Further another object of the present invention is to provide an iris for a photographing apparatus that can reduce ghost generation by reducing an amount of reflected light.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an iris for a photographing apparatus, the iris including: a plate including a transmission hole therein; a plurality of iris wings movably provided on one side of the plate; a motor for providing power used to move the iris wings; and a filter unit provided inside the iris wings to control an amount of transmitted light that passes through the transmission hole, wherein the filter unit is at least a portion of the iris wing.

In another aspect of the present invention, there is provided an iris for a photographing apparatus, the iris including: a plate including a transmission hole of a predetermined size at a center thereof; a motor provided on one side of the plate; first and second iris wings connected to the motor to control an amount of light that passes through the transmission hole; and filter units provided to one sides of the iris wings, respectively, to control a degree of light transmission, wherein the filter unit includes a semi-transmission part having at least predetermined light transmittance, and an opaque part for blocking transmission of light.

According to an iris for a photographing apparatus of the present invention, an iris wing and an ND filter are integrally formed, so that the iris has a thin thickness and a simple structure, which makes manufacturing of the iris easy.

Also, according to the present invention, a problem that two iris wings are hooked by each other when they are slid horizontally to cross each other is solved.

Also, according to the present invention, an amount of reflected light reduces, so that possibility that ghost is generated reduce.

Also, since the shape of a semi-transparent part formed in an ND filter can be freely determined, processing of the ND filter is simplified.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a related art iris for a photographing apparatus;

FIG. 2 is a view illustrating an iris wing of the related art iris;

FIG. 3 is a front view of an iris for a photographing apparatus according to the present invention;

FIG. 4 is a rear side view of an iris for a photographing apparatus according to the present invention;

FIG. 5 is a front view of a first iris wing according to the present invention;

FIG. 6 is a front view of a second iris wing according to the present invention;

FIG. 7 is a view illustrating a transmission hole of an iris for a photographing apparatus according to the present invention is open by half to transmit predetermined light;

FIG. 8 is a view illustrating a transmission hole of an iris for a photographing apparatus according to the present invention is open at the maximum;

FIG. 9 is a front view of a first iris wing constituting an iris for a photographing apparatus according to another embodiment of the present invention;

FIG. 10 is a front view of a second iris wing constituting an iris for a photographing apparatus according to another embodiment of the present invention;

FIG. 11 is a view illustrating a structure of an ND filter according to another embodiment of the present invention;

FIG. 12 is a view illustrating a transmission hole formed in an iris is completely opened by an ND filter according to the present invention;

FIG. 13 is a view illustrating a transmission hole is almost closed by movement of an ND filter according to the present invention;

FIG. 14 is a view illustrating a transmission hole is completely closed by movement of an ND filter according to the present invention; and

FIGS. 15 to 19 are views illustrating a shape of an ND filter according to other embodiments of the present invention.

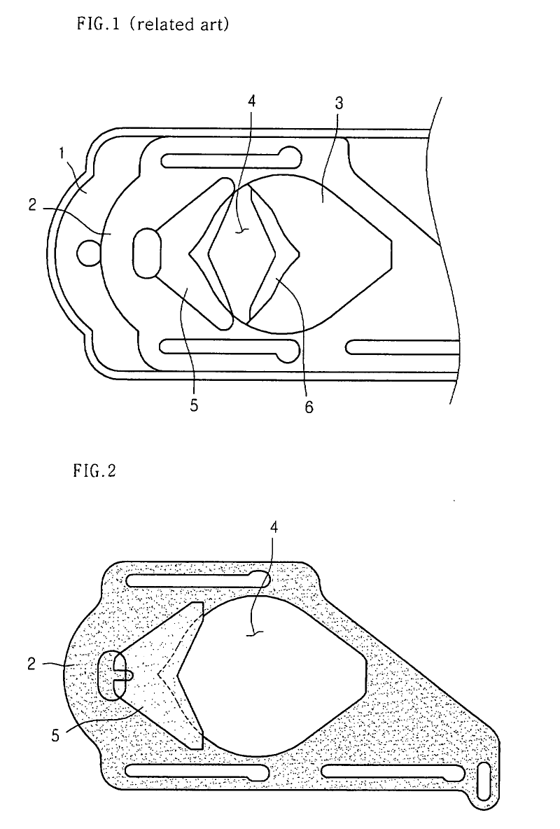

### DETAILED DESCRIPTION OF THE ILLUSTRATED EMBODIMENTS

Reference will now be made in detail to the preferred embodiments of the present invention, examples of which are illustrated in the accompanying drawings. However, the present invention is not limited to the described embodiments, and it is noted that a person of ordinary skill in the art to which the invention pertains would have easily proposed other invention or embodiments of the present invention which fall within the sprit of the present invention by addition, modification, and deletion of other element.

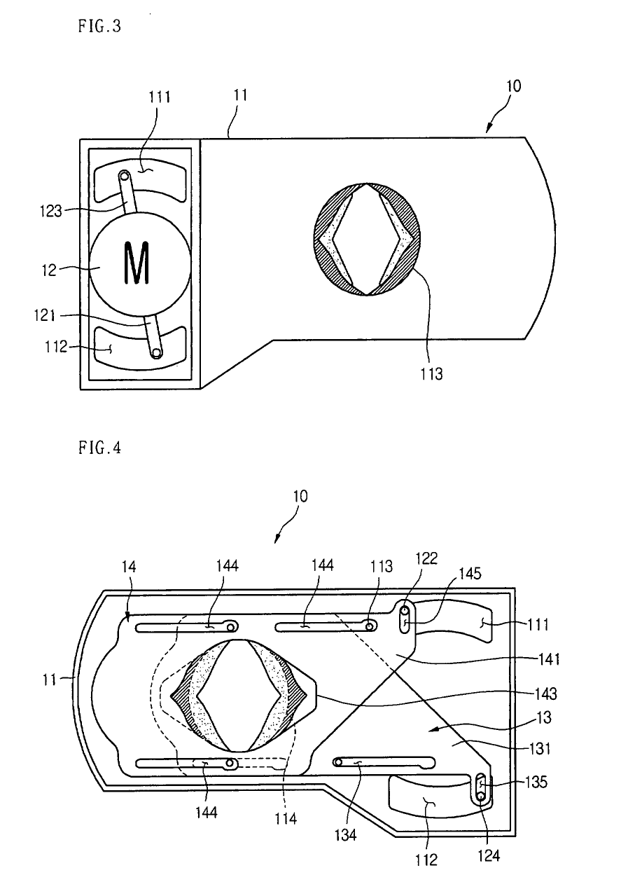

FIG. 3 is a front view of an iris for a photographing apparatus according to the present invention, and FIG. 4 is a rear side view of an iris for a photographing apparatus according to the present invention.

Referring to FIGS. 3 and 4, the iris of the photographing apparatus 10 includes a plate 11 including a transmission hole 113 of a predetermined size formed at the center of the plate 11, a motor 12 provided on one side of the plate 11, and a first iris wing 13 and a second iris wing 14 slid horizontally by the motor 12.

In detail, a first connecting shaft 121 and a second connection shaft 123 are rotatably connected to the motor 12. Therefore, as the motor 12 rotates in forward direction, the first and second connection shafts 121 and 123 rotate clockwise or counterclockwise.

Also, protrusions 122 and 123 protruding to the rear side of the plate 11 are formed at ends of the first and second connection shafts 121 and 123. Also, guide holes 111 and 112 for receiving the protrusions 122 and 124 to rotate the first and second connection shafts 121 and 123 in a forward or backward direction within a predetermined angle range are formed in the plate 11.

Also, protrusion holes 135 and 145 at which the protrusions 122 and 124 are hooked are formed at one ends of the first and second iris wings 13 and 14.

Therefore, when the motor 12 rotates in one direction, the first and second iris wings 13 and 14 slide in opposite directions, respectively, to allow the transmission hole 113 to be opened or closed.

Also, a plurality of guide protrusions 114 are formed on the rear side of the plate 11. A plurality of guide holes 134 and 144 at which a guide protrusion 114 is hooked are formed in the upper end of the second iris wing 14 and the lower end of the first iris wing 13. Therefore, when the motor 12 rotates, movements of the iris wings 13 and 14 in horizontal direction are guided by the guide holes 134 and 144. Also, the guide holes 134 and 144 and guide protrusion 114 allow the iris wings 13 and 14 to freely move without being detached from the plate 11.

Meanwhile, the first and second iris wings 13 and 14 are stacked and coupled on the rear side of the plate 11. Therefore, the first and second iris wings 13 and 14 plane-contact each other when they slide in opposite directions. The transmission hole 113 is opened or closed as the first and second iris wings 13 and 14 move.

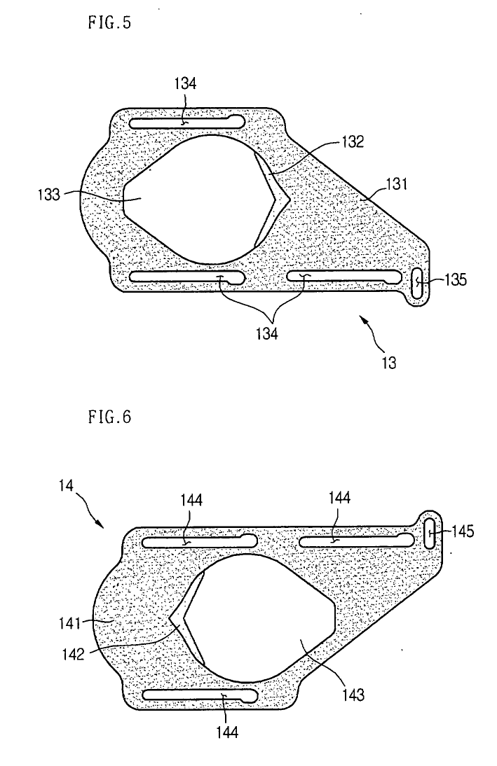

FIG. 5 is a front view of a first iris wing according to the present invention, and FIG. 6 is a front view of a second iris wing according to the present invention.

Referring to FIG. 5, the first iris wing 13 according to the present invention includes a transparent part 133 formed transparent at the center to transmit light by 100%, a semi-transparent part 132 formed on one side of the transparent part 133 and having predetermined transmittance, and an opaque part 131 constituting a portion excluding the transparent part 133 and the semi-transparent part 132 to prevent light transmission. Also, as illustrated, the opaque part 131 forms a main body of the first iris wing 13.

Also, like the first iris wing 13, the second iris wing 14 includes an opaque part 141, a semi-transparent part 142, and a transparent part 143.

Here, the semi-transparent parts 132 and 142 serve as a related art ND filter. Also, the semi-transparent part 132 of the first iris wing 13 and the semi-transparent part 142 of the second iris wing 14 are formed in portions facing each other.

Therefore, as a distance between the semi-transparent parts 132 and 142 gets close, the transmission hole 113 formed in the plate 11 is shielded by the opaque parts 131 and 141 to reduce light transmission. On the other hand, as the distance between the semi-transparent parts 132 and 142 gets distant, the areas of the opaque parts 133 and 143 increase, so that light transmission increases.

FIG. 4 is a view illustrating the transmission hole 113 is completely open. Referring to FIG. 4, portions of the semi-transparent parts 132 and 142 are located inside the transmission hole 113. However, the semi-transparent parts 132 and 142 can be located in an complete outside of the transmission hole 113, which is a mere difference in design.

Meanwhile, the opaque parts 131 and 141, and the semi-transparent parts 132 and 142 can be formed by painting relevant parts black or printing. For example, the iris wings 13 and 14 can be manufactured using a transparent filter, portions of the iris wings 13 and 14 can be painted black or a corresponding printing process can be performed on the portions of the iris wings 13 and 14, and a semi-transparent painting operation or a corresponding printing process can be performed on the other portions of the iris wings 13 and 14 to allow only a portion of light to pass through the portions.

Here, the transparent parts 133 and 143 correspond to a hole formed in a related art iris wing, and the semi-transparent part 142 corresponds to an ND filter. That is, the semi-transparent part 142 forms an integral body in cooperation with the iris wing to serve as an ND filter.

Also, since the semi-transparent parts 132 and 142 have predetermined transmittance that allows only 50% or 25% of light to pass through the semi-transparent parts 132 and 142, a range of controlling an amount of light incident onto the image sensor extends.

Meanwhile, the semi-transparent parts 132 and 142 can be formed in various shapes such as a V-shape, a circular shape, and a line shape. As the first and second iris wings 13 and 14 slide horizontally to cross and overlap each other, an effect of controlling an amount of light by the iris 10 can be enhanced by the shapes of the semi-transparent parts 132 and 142. Also, since the shapes of the semi-transparent parts 132 and 142 can be freely controlled by modification of a painting operation or a printing process, a manufacturing process thereof is remarkably simplified in comparison with a process of cutting the ND filter in the above-described shape.

Also, since the first and second iris wings 13 and 14 formed of one material perform the function of an iris wing formed of a separate element and material, and the function of an ND filter, the thickness of the iris 10 becomes thin and manufacturing the iris 10 becomes easy.

Also, according to the iris 10 of the present invention, a problem that the ND filter is separated from the iris wing while the first and second iris wings 13 and 14 slide horizontally is solved.

Also, according to the iris 10 of the present invention, ghost generation reduces because an ND filter causing reflection seriously is removed.

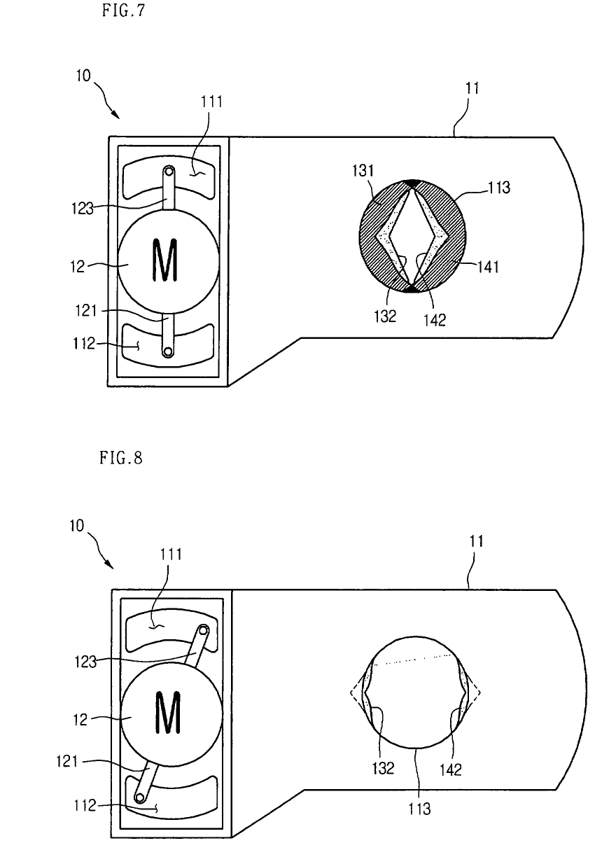

FIG. 7 is a view illustrating a transmission hole of an iris for a photographing apparatus according to the present invention is open by half to transmit predetermined light, and FIG. 8 is a view illustrating a transmission hole of an iris for a photographing apparatus according to the present invention is open at the maximum.

In detail, FIG. 4 is a rear side view of an iris for a photographing apparatus when the transmission hole 113 is open at the maximum, and FIG. 8 is a view illustrating a transmission hole of an iris for a photographing apparatus is open at the maximum.

FIG. 7 illustrates the state of the iris for the case where an object is a somewhat dark object, or a shooting spot is a somewhat dark place. That is, the first and second iris wings 13 and 14 slide in directions in which they get away from each other, so that the transmission hole 113 is open by half. Accordingly, a predetermined amount of light is incident onto the image sensor.

FIGS. 4 and 8 illustrate the state of the iris for the case where an object is located in a very dark place.

That is, the first and second iris wings 13 and 14 slide to a maximum distant state, so that the transmission hole 113 is completely open. In this case, the semi-transparent parts 132 and 142 of the iris wings 13 and 14 are located completely outside the transmission hole 113, or only portions of the semi-transparent parts 132 and 142 are located on the edge of the transmission hole 113.

Meanwhile, in the case where an object is an object of red color or is located in a bright place, the transmission hole 113 should be shielded. In this case, the motor 12 rotates in a direction opposite to a process of opening the transmission hole 113. Also, the first and second iris wings 13 and 14 slide in directions such that they mutually get close. In other words, the iris wings 13 and 14 move in directions such that the semi-transmission parts 132 and 142 mutually get close.

When the transmission hole 113 is completely closed, the semi-transparent parts 132 and 142 of the first and second iris wings 13 and 14 overlap each other at the center of the transmission hole 113. Also, a portion where the semi-transmission parts 132 and 142 overlap becomes opaque to block light transmission.

In detail, the most portion of the transmission hole 113 is shielded by the opaque parts 131 and 141, and the center portion of the transmission hole 113 becomes opaque while the semi-transparent parts 132 and 142 overlap each other.

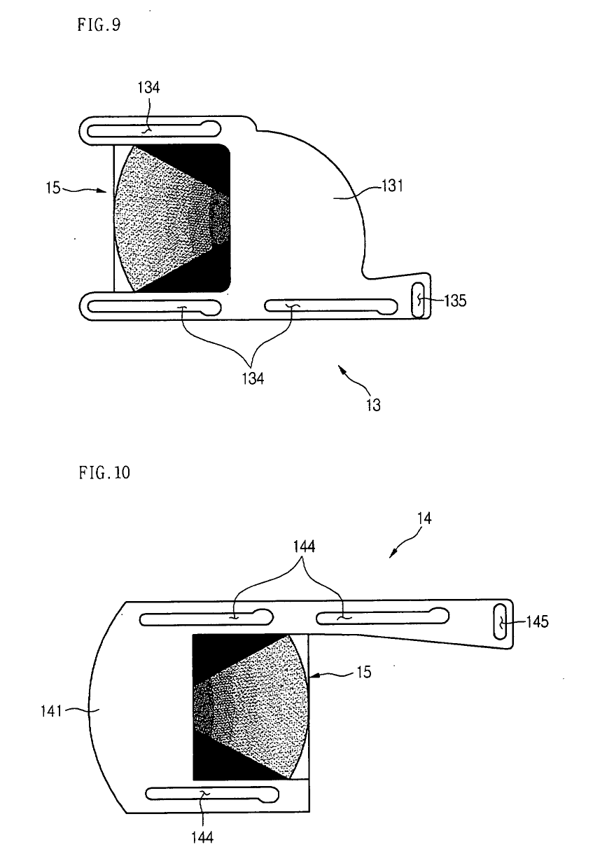

FIG. 9 is a front view of a first iris wing constituting an iris for a photographing apparatus according to another embodiment of the present invention, and FIG. 10 is a front view of a second iris wing constituting an iris for a photographing apparatus according to another embodiment of the present invention.

Referring to FIGS. 9 and 10, the constructions of the iris wings 13 and 14 according to the present invention are mostly the same as those of the iris wings shown in FIGS. 3 to 8, and only different from those of the iris wings shown in FIGS. 3 to 8 in the method for forming the portion that performs an ND filter function. Therefore, description of the same elements as those of the iris wing shown in FIGS. 3 to 8 will be omitted. Also, it is noted that the shape of the iris wing is not limited to the shape proposed by the present embodiment.

In detail, the iris structure according to the present embodiment is the same as a related art iris structure in that the separate ND filters 15 are mounted on the iris wings 13 and 14, respectively, but is different from the related art iris structure in that the opaque part and the semi-transparent part are separately printed on the ND filter 15. Also, the transmission hole 113 is shielded or opened as the ND filters 15 mutually get close to or get away from each other.

Here, the ND filters 15 may be mounted as separate elements on the iris wings 13 and 14. Also, portions of the iris wings 13 and 14 are separately painted or printed so that an ND filter and the iris wing are integrally formed. That is, an ND filter portion can be integrally formed together with the iris wing.

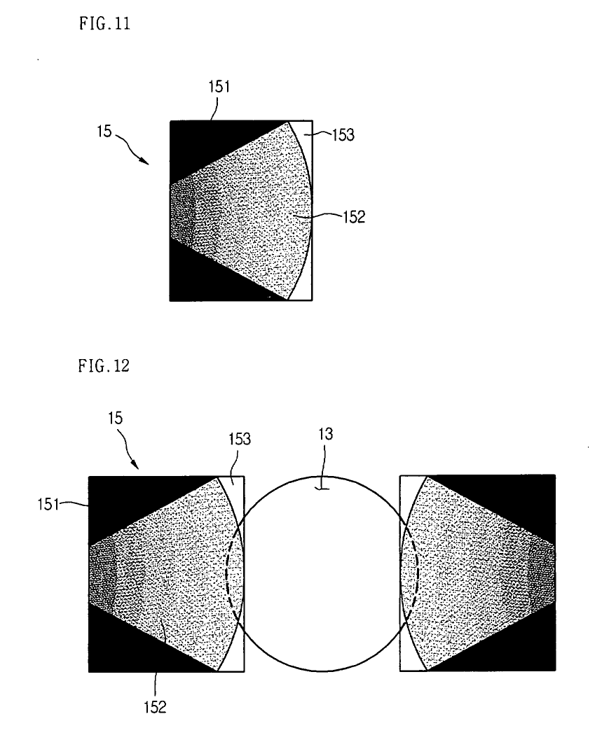

FIG. 11 is a view illustrating a structure of an ND filter according to another embodiment of the present invention.

Referring to FIG. 11, the ND filter 15 is formed in a rectangular shape. The ND filter 15 includes a semi-transparent part 152 having predetermined transmittance, a transparent part 153 formed at the end of the semi-transparent part 152 to completely transmit light, and an opaque part 151 for blocking light transmission except the semi-transparent part 152 and the transparent part 153.

Here, the semi-transparent part 152 and the opaque part 151 are formed using printing. For example, the semi-transparent part 152 having predetermined transmittance is printed on the transparent ND filter 15 that completely transmits light, and a portion of the ND filter 15 that excludes the semi-transparent part 152 and the transparent part 153 are printed black to block light transmission. Also, the semi-transparent part 152 can be formed to have transmittance continuously changing from one end to the other end of the ND filter 15. Accordingly, image quality and reliability of an auto focus operation of a lens can improve. Also, the semi-transparent part 152 can be formed to have a shape whose area extends in a direction along which transmittance increases.

Since the above-described structure of the ND filter 15 allows the transparent part, semi-transparent part, and the opaque part to be formed through a printing process, and the semi-transparent part to be formed to have various shapes, a manufacturing process of the ND filter is simplified. In other words, since the ND filter does not need to be cut depending on the shape of the semi-transparent part, the number of processes reduces.

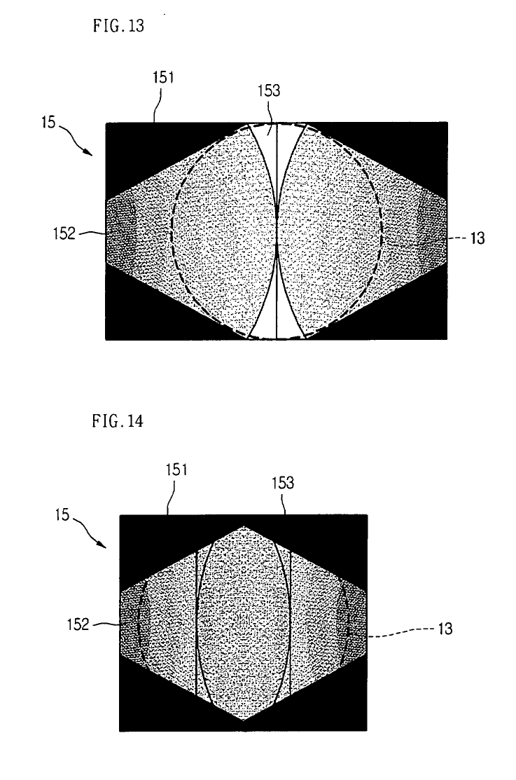

FIG. 12 is a view illustrating a transmission hole formed in an iris is completely opened by an ND filter according to the present invention, FIG. 13 is a view illustrating a transmission hole is almost closed by movement of an ND filter according to the present invention, and FIG. 14 is a view illustrating a transmission hole is completely closed by movement of an ND filter according to the present invention.

Referring to FIGS. 12 and 14, an opening degree of a transmission hole 113 formed in the plate 11 constituting the iris according to the present invention is controlled by horizontal movements of the iris wings 13 and 14.

In detail, the transparent parts 153 of the ND filters 15 are mounted on the first and second iris wings 13 and 14, respectively, to face each other. Of course, the ND filters 15 can be integrally printed on the iris wings 13 and 14.

In more detail, the iris wings 13 and 14 on which the ND filters 15, respectively, are slid in directions in which they get close to or away from each other by forward rotation or backward rotation of the motor 12. During this process, the ND filters 15 move in directions in which they get close to or away from each other.

When the iris wings 13 and 14 are located at the maximum distant position, the transmission hole 113 maintains a complete open state as illustrated in FIG. 12. That is, only portions of the transparent parts 153 and semi-transparent parts 152 are located on the edge of the transmission hole 113, or located outside the edge of the transmission hole 113.

Also, as the motor 12 rotates backward and the ND filters 15 move in directions in which they get close to each other, the semi-transparent part 152 of the ND filter 15 enters the inside of the transmission hole 113. Also, an amount of light transmission is controlled by a degree the semi-transparent part 152 enters the inside of the transmission hole 113. Also, the semi-transparent part 152 is formed to have continuously changing transmittance, so that a range of controlling light transmittance become very wide. In other words, controlling an amount of light is performed more precisely in comparison with a related art iris structure.

Meanwhile, when the ND filters 15 are located at a closest position, the transparent part 153 transmits a portion of light as illustrated in FIG. 13, or portions of the ND filters 15 can overlap each other to completely block light transmission as illustrated in FIG. 14.

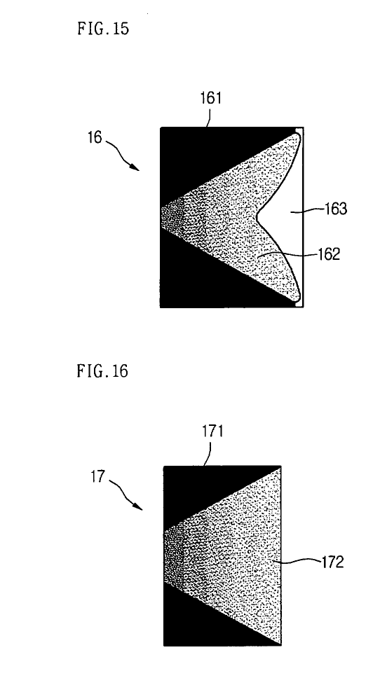

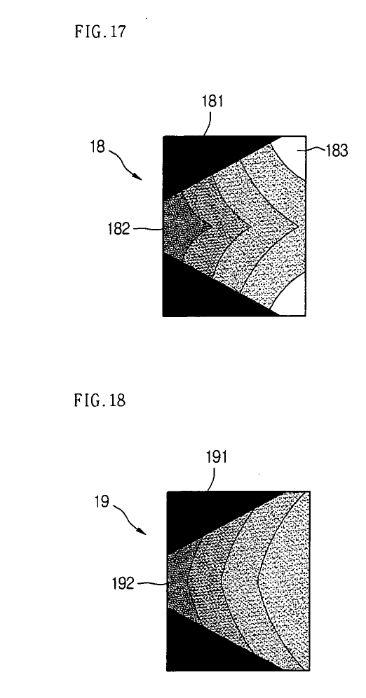

FIGS. 15 to 19 are views illustrating shapes of ND filters according to other embodiments of the present invention.

Referring to FIGS. 15 to 19, the ND filters 16 to 20 include semi-transparent parts 162, 172, 182, 192, and 202 where a portion having predetermined transmittance is formed in a V-shape, transparent parts 163, 183, 193, and 203, and opaque parts 161, 171, 181, 191, and 201.

In detail, the semi-transparent part can be formed to have transmittance that gradually changes along a predetermined direction, and can have various shapes.

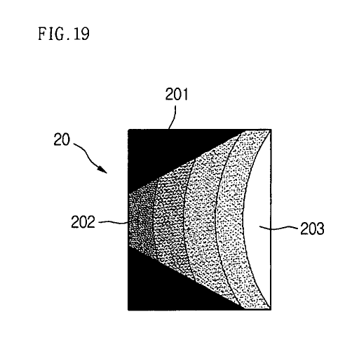

In the case of FIG. 11, the semi-transparent part is formed to have gradually increasing light transmittance from one end to the other end of the ND filter, and has an arc shape having a predetermined curvature radius. Also, FIG. 19 illustrates the semi-transparent part is formed in a shape symmetric with that of FIG. 11.

Also, in the case of FIG. 15, the semi-transparent part is formed in a line shape, and the end of the semi-transparent part is formed such that a central portion of the end is recessed to a predetermined depth. In this case, the shape of the transmission hole through which light passes, that is, the shape of the transparent part forms a shape close to a circular shape.

Also, in the case of FIG. 16, there is no transparent part, and the ND filter 17 consists of only a semi-transparent part 172. Therefore, an area formed by the ND filters 17 separating from each other corresponds to a transparent area to transmit 100 of incident light and condense the light onto an image sensor.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An iris for a photographing apparatus, the iris comprising:
a plate including a transmission hole therein;
a plurality of iris wings movably provided on one side of the plate;
a motor for providing power used to move the iris wings; and
a filter unit provided inside the iris wings to control an amount of transmitted light that passes through the transmission hole, wherein the filter unit is at least portions of the iris wings.

2. The iris according to claim 1, wherein the filter unit comprises:
a transparent part for transmitting an entire amount of light incident to the transmission hole;
a semi-transparent part for transmitting a portion of light incident thereto; and
an opaque part for blocking light transmission.

3. The iris according to claim 2, wherein the iris wings are formed of a transparent material, the semi-transparent part is printed to have predetermined transmittance, and the opaque part is printed to block light transmission.

4. The iris according to claim 2, wherein the transparent part is formed at centers of the iris wings, and the semi-transparent part is formed at an edge on one side of the transparent part.

5. The iris according to claim 2, wherein the semi-transparent part is formed in at least one of a V-shape, a curved shape, and a line shape.

6. An iris for a photographing apparatus, the iris comprising:
a plate including a transmission hole of a predetermined size at a center thereof;
a motor provided on one side of the plate;
first and second iris wings connected to the motor to control an amount of light that passes through the transmission hole; and
filter units provided in one sides of the iris wings, respectively, to control a degree of light transmission, wherein the filter units include a semi-transmission part having at least predetermined light transmittance, and an opaque part for blocking light transmission.

7. The iris according to claim 6, wherein the filter units are portions of the iris wings.

8. The iris according to claim 6, wherein the filter units are separately attached on one sides of the iris wings.

9. The iris according to claim 6, further comprising a transparent part provided to an end of the semi-transparent part to transmit an entire amount of light.

10. The iris according to claim 6, wherein the filter units are formed of a transparent material transmitting an entire amount of light, the semi-transparent part is printed on portions of the filter units to have predetermined transmittance, and the opaque part is printed to block light transmission.

11. The iris according to claim 6, wherein the semi-transparent part is printed to have transmittance changing from one end to the other end.

12. The iris according to claim 6, wherein the semi-transparent part is printed to have transmittance that increases toward a center of the transmission hole with the transmission hole completely open.

13. The iris according to claim 6, wherein the semi-transparent part is printed to have a shape that extends toward a center of the transmission hole with the transmission hole completely open.

14. The iris according to claim 6, wherein the opaque part is formed on an outer side of the semi-transparent part.

15. The iris according to claim 6, wherein the first and second iris wings are slid in a direction in which they mutually close to or get away from each other by the motor, and an amount of transmitted light that passes through the transmission hole is controlled while the filter units formed in the first and second iris wings, respectively, overlap each other.
